(19) United States
(12) Patent Application Publication
(10) Pub. No.: US 2015/0262162 A1
(43) Pub. Date: Sep. 17, 2015

(54) MOBILE TERMINAL, METHOD FOR CONTROLLING MOBILE TERMINAL, PROGRAM PRODUCT, AND RECORDING MEDIUM

(71) Applicant: RAKUTEN, INC., Tokyo (JP)

(72) Inventors: Hideki Akashika, Shinagawa-ku (JP); Yutaka Jinno, Shinagawa-ku (JP)

(73) Assignee: RAKUTEN, INC., Tokyo (JP)

(21) Appl. No.: 14/439,321

(22) PCT Filed: Oct. 31, 2012
(86) PCT No.: PCT/JP2012/078253

§ 371 Date: Apr. 29, 2015

(51) Int. Cl. G06Q 20/32; G06Q 20/08

(52) U.S. Cl. CPC G06Q 20/3221; G06Q 20/085; G06Q 40/02

(57) ABSTRACT

The objective is to allow a portable terminal to access a contactless type IC module with a timing that is resistant to receiving effects of other processing and that is unlikely to impart effects to other processing. An asynchronous payment terminal plays a sound effect indicating settlement completion or settlement failure from a speaker, which is detected by a microphone of a mobile terminal. An electronic money application determines whether the sound effect detected by the microphone is a sound effect produced when payment is completed or a sound effect produced when payment is impossible. The electronic money application makes this determination by comparing the sound effect with a sound pattern stored in a storing section of the mobile terminal. If the sound effect is the sound effect for the case of settlement completion, a charge is performed under fixed conditions. If the electronic money application determines that the sound effect indicating that the payment is impossible has been detected, since there is not enough value balance, the electronic money application immediately performs recharging processing.

The present invention relates to mobile terminals, methods for controlling the mobile terminal, program products, and recording media.

### BACKGROUND ART

In recent years, the use of electronic money has become widespread. In electronic money, amount information called value is related to money value and fund settlement is performed by increasing or decreasing the value balance.

FIG. 14 is a diagram for explaining an existing electronic money system.

A mobile terminal 5 is a mobile terminal owned by the user, and the balance of value, an IC module ID by which an IC module is identified, an electronic money number, and so forth are stored in an IC module incorporated into or attached to the mobile terminal 5. Moreover, there is also an electronic money card 100 incorporating the IC module.

A method of holding value in a user's-side IC module in this manner is called a stored value type.

An asynchronous payment terminal 7 is installed in a store, an automatic vending machine, and so forth, and performs payment by value by reducing the value balance stored in the IC module by performing short-distance radio communication with the IC module of the mobile terminal 5 or the electronic money card 100.

The asynchronous payment terminal 7 completes the payment processing locally between the asynchronous payment terminal 7 and the IC module without connecting to an electronic money server 2 and records the transaction history as log data.

Then, the asynchronous payment terminal 7 collectively sends the log data to the electronic money server 2 later at regular or irregular intervals.

The reason why the asynchronous payment terminal 7 is called “asynchronous” is that the asynchronous payment terminal completes the payment processing locally without being synchronous with the electronic money server 2.

In such a system of stored value-type electronic money, since the value balance is stored in the IC module in advance and the value balance is reduced at the time of payment, if there is not enough value, it is impossible to perform payment. For this reason, processing called recharging that increases the balance of value stored in the IC module is required. This recharging is generally performed in exchange for money in a store and the exchange value of value is guaranteed.

In recent years, with an improvement in the communications capacity of the network, a server management-type system that manages value with the electronic money server 2 and performs payment processing on the server's side has also become known. It is expected that, with the improvement of a network infrastructure, such a server management-type system will become gradually widespread.

Such a kind of electronic money that manages value with the server is called server-type electronic money. In a system of this server-type electronic money, since value is not managed by an IC module, it is necessary to synchronize it with value managed by the electronic money server 2 at all times. Therefore, a payment terminal used is a synchronous-type payment terminal, not the asynchronous payment terminal 7.

Incidentally, a noncontact IC module performs exclusive control in order to maintain the consistency of data stored therein when, for example, a plurality of accesses by which rewriting of data occurs are made at the same time.

Hereinafter, descriptions will be given by using a specific example. Some noncontact IC modules have a non-cipher mode in which simple data is sent and received and a cipher mode in which a transaction including rewriting of important data or the like is conducted. In the case of the non-cipher mode, the access time is extremely short and concurrent access is not accepted, but a response is sent back to each access made from a plurality of processes if they do not overlap with each other.

On the other hand, in the case of the cipher mode, since there is a possibility that a contradiction in the value balance or the like arises if concurrent access is permitted, when any one of the two processes that are making accesses at almost the same time enters the cipher mode, it becomes temporarily impossible for the other process to enter the cipher mode. On the other hand, if an access request is issued from the other process while one process is making access in the cipher mode, higher priority is given to the process which made access later and the process which made access first is terminated.

For example, while automatic recharging in which access is made to the IC module from the electronic money server 2 via the mobile terminal 5 at regular intervals (for example, refer to Patent Document 1) is being performed, if a passage through an automatic ticket wicket is conducted (that is, if a reader/writer incorporated into an automatic ticket checker accesses the IC module while the electronic money 2 is accessing the IC module in the cipher mode), since higher priority is given to the latter, the automatic recharging which is being processed is stopped.

Moreover, for example, if the above-described automatic recharging is started while payment processing with a payment terminal (in particular, a synchronous-type payment terminal) is being performed, since higher priority is given to the latter, the payment processing is stopped.

### CITATION LIST

### Patent Literature

Patent Document 1: JP-A-2005-25618

### DISCLOSURE OF INVENTION

### Problem to be Solved by the Invention

As described above, if a conflict between processing making access to a noncontact IC module incorporating a conflict controlling function occurs, one processing is stopped, which is inconvenient.

For example, regular automatic recharging described in Patent Document 1 is not only limited by the other processing, but also sometimes limits the other processing.

A problem to be solved by the present invention is to access a noncontact IC module with timing which is less likely to be affected by the other processing and is less likely to affect the other processing.

### SUMMARY OF THE INVENTION

The invention described in claim 1 provides a mobile terminal comprising: a storing unit that stores a procedure of a group of processing that establishes access to a balance in a state in which the procedure is related to a sound pattern of a sound effect which is output at an end of a transaction which changes a balance that is stored in an IC module including a unit that stores a balance of electronic value and a unit that changes the balance by using balance change information; a controlling unit that controls a sound inputting unit such that the sound effect which is output at the end of the transaction which changes the balance is input from a payment terminal including a unit that changes the balance by sending the balance change information to the IC module; and an executing unit that executes the group of processing by the procedure stored in the storing unit in a state in which the procedure is related to the sound pattern when a sound indicating the sound pattern corresponding to the sound effect is input via the sound inputting unit.

The invention described in claim 2, provides the mobile terminal according to claim 1, wherein the storing unit stores a procedure of necessity determination processing that determines a necessity or not of addition to the balance in a state in which the procedure is related to a sound pattern of a completion sound indicating the sound effect which is output when the balance stored in the IC module has been changed, and if a sound indicating the sound pattern corresponding to the completion sound is input via the sound inputting unit, the executing unit executes the necessity determination processing by the procedure stored in the storing unit in a state in which the procedure is related to the sound pattern.

The invention described in claim 3, the mobile terminal according to claim 2, wherein the necessity determination processing is processing by which a necessity or not of addition to the balance is determined by using predetermined data which is acquired from the IC module, and the executing unit includes a data acquiring unit that acquires the predetermined data stored in the IC module and a necessity determining unit that determines a necessity or not of addition to the balance by using the predetermined data which is acquired by the acquiring unit.

The invention described in claim 4, the mobile terminal according to claim 3, wherein the data acquiring unit includes a balance acquiring unit that acquires the balance stored in the IC module, and the necessity determining unit determines that there is a need to perform addition to the balance if the balance which is acquired by the balance acquiring unit is less than or equal to a predetermined threshold value or is less than the predetermined threshold value.

The invention described in claim 5, the mobile terminal according to claim 3 or 4, wherein the IC module further includes a unit that stores log data containing an amount of change indicating a reduction or an increase of the balance by the transaction, the data acquiring unit includes a change amount acquiring unit that acquires the amount of change contained in latest log data from the IC module, and the necessity determining unit that determines that there is a need to perform addition to the balance if the amount of change which is acquired by the change amount acquiring unit indicates a reduction and an amount of reduction indicated by the amount of change is more than or equal to a predetermined threshold value or is more than the predetermined threshold value.

The invention described in claim 6, the mobile terminal according to any one of claims 2 to 5, wherein the IC module further includes a unit that stores log data containing an amount of change indicating a reduction or an increase of the balance by the transaction, the data acquiring unit includes a change amount acquiring unit that acquires the amount of change contained in latest log data from the IC module, and the necessity determining unit determines that there is no need to perform addition to the balance if the amount of change which is acquired by the change amount acquiring unit indicates an increase.

The invention described in claim 7, the mobile terminal according to any one of claims 2 to 6, wherein the storing unit further stores a procedure of balance addition processing by which addition to the balance stored in the IC module is performed, the balance addition processing which is to be executed if determination is made in the necessity determination processing that there is a need to perform addition to the balance, and if determination is made by the necessity determining unit that there is a need to perform addition to the balance, the executing unit further including an addition requesting unit that sends a balance addition request to a server device provided with a unit generating the balance change information and a balance change information transferring unit that acquires balance change information which increases the balance stored in the IC module and transfers the balance change information to the IC module executes the balance addition processing by the procedure stored in the storing unit.

The invention described in claim 8, the mobile terminal according to any one of claims 2 to 6, wherein the storing unit further stores a procedure of balance addition reservation processing by which addition to the balance stored in the IC module is performed with designated timing, the balance addition reservation processing which is to be executed if determination is made in the necessity determination processing that there is a need to perform addition to the balance, and if determination is made by the necessity determination unit that there is a need to perform addition to the balance, the executing unit further including a unit that makes a reservation such that a balance addition request is sent, with designated timing, to a server device provided with a unit generating the balance change information, an addition requesting unit that sends the balance addition request to the server device with the designated timing, and a balance change information transferring unit that acquires balance change information which increases the balance stored in the IC module and transfers the balance change information to the IC module executes the balance addition reservation processing by the procedure stored in the storing unit.

The invention described in claim 9, the mobile terminal according to any one of claims 2 to 8, wherein as the completion sound, there are a reduction completion sound which is output when the balance stored in the IC module has been reduced and an increase completion sound which is output when the balance has been increased, the storing unit stores a procedure of necessity determining processing by which a necessity or not of addition to the balance is determined in a state in which the procedure is related to a sound pattern of the reduction completion sound, and the executing unit executes the necessity determining processing by the procedure stored in the storing unit in a state in which the procedure is related to the sound pattern only when a sound indicating the sound pattern corresponding to the reduction completion sound is input via the sound inputting unit.

The invention described in claim 10, the mobile terminal according to any one of claims 1 to 9, wherein the storing unit further stores a procedure of balance addition processing by which addition to the balance is performed in a state in which the procedure is related to a sound pattern of a sound indicating that a change in the balance is impossible, the sound indicating the sound effect or an audio message which is output when the balance stored in the IC module has not been successfully changed, and if a sound indicating the sound pattern corresponding to the sound indicating that a change in the balance is impossible is input via the sound inputting unit, the executing unit executes the balance addition processing by the procedure stored in the storing unit in a state in which the procedure is related to the sound pattern.

The invention described in claim 11, the mobile terminal according to claim 10, wherein the executing unit includes an addition request amount sending unit that sends an addition request amount to a server device provided with a unit generating the balance change information, and a balance change information transferring unit that acquires balance change information which increases the balance stored in the IC module by the addition request amount and transfers the balance change information to the IC module.

The invention described in claim 12, the mobile terminal according to claim 11, wherein the executing unit includes a designated amount acquiring unit that acquires a designated amount which is designated by a user, and an addition request amount setting unit that sets the addition request amount such that the balance stored in the IC module becomes more than or equal to the designated amount which is acquired by the designated amount acquiring unit.

The invention described in claim 13, the mobile terminal according to claim 11, wherein the executing unit includes an image acquiring unit that acquires an image obtained by taking an image of a payment amount which is displayed on a display device of the payment terminal, and an addition request amount setting unit that sets the addition request amount such that the balance stored in the IC module becomes more than or equal to the payment amount which is identified based on the image which is acquired by the image acquiring unit.

The invention described in claim 14, the mobile terminal according to claim 11, wherein the executing unit includes an addition request amount acquiring unit that acquires an addition request amount which is designated by a user.

The invention described in claim 15, the mobile terminal according to any one of claims 1 to 14, wherein the controlling unit switches the sound inputting unit to ON when an electromagnetic wave of a particular frequency is detected by a unit that detects an electromagnetic wave of a particular frequency.

The invention described in claim 16, the mobile terminal according to any one of claims 1 to 15, further comprising: an acceleration sensor that detects a movement of the mobile terminal; and an acceleration-related data storing unit that stores a predetermined movement pattern or threshold value of an acceleration of the movement, wherein the controlling unit switches the sound inputting unit to ON when the predetermined movement pattern or a movement exceeding the predetermined threshold value of the acceleration, the predetermined movement pattern or threshold value which is stored in the acceleration-related data storing unit, is detected by the acceleration sensor.

The invention described in claim 17, the mobile terminal according to any one of claims 1 to 16, wherein the controlling unit switches the sound inputting unit to ON when the controlling unit enters a predetermined location, a predetermined situation, or a predetermined period of time.

The invention described in claim 18, the mobile terminal according to any one of claims 15 to 17, wherein the controlling unit switches the sound inputting unit to OFF when a sound indicating a sound pattern corresponding to the sound effect is input via the sound inputting unit.

The invention described in claim 19, the mobile terminal according to any one of claims 1 to 18, wherein the controlling unit switches the sound inputting unit to OFF when a predetermined time has elapsed after the controlling unit has switched the sound inputting unit to ON.

The invention described in claim 20, a method for controlling a mobile terminal including a storing unit that stores a procedure of a group of processing that establishes access to a balance in a state in which the procedure is related to a sound pattern of a sound effect which is output at an end of a transaction which changes a balance that is stored in an IC module including a unit that stores a balance of electronic value and a unit that changes the balance by using balance change information, the method comprising: a controlling step of controlling a sound inputting unit such that the sound effect which is output at the end of the transaction which changes the balance is input from a payment terminal including a unit that changes the balance by sending the balance change information to the IC module; and an executing step of executing the group of processing by the procedure stored in the storing unit in a state in which the procedure is related to the sound pattern when a sound indicating the sound pattern corresponding to the sound effect is input via the sound inputting unit.

The invention described in claim 21, a program product for making a mobile terminal implement, the mobile terminal including a storing unit that stores a procedure of a group of processing that establishes access to a balance in a state in which the procedure is related to a sound pattern of a sound effect which is output at an end of a transaction which changes a balance that is stored in an IC module including a unit that stores a balance of electronic value and a unit that changes the balance by using balance change information: a controlling function of controlling a sound inputting unit such that the sound effect which is output at the end of the transaction which changes the balance is input from a payment terminal including a unit that changes the balance by sending the balance change information to the IC module; and an executing function of executing the group of processing by the procedure stored in the storing unit in a state in which the procedure is related to the sound pattern when a sound indicating the sound pattern corresponding to the sound effect is input via the sound inputting unit.

The invention described in claim 22, a computer-readable recording medium on which a program product is recorded, the program product for making a mobile terminal implement, the mobile terminal including a storing unit that stores a procedure of a group of processing that establishes access to a balance in a state in which the procedure is related to a sound pattern of a sound effect which is output at an end of a transaction which changes a balance that is stored in an IC module including a unit that stores a balance of electronic value and a unit that changes the balance by using balance change information: a controlling function of controlling a sound inputting unit such that the sound effect which is output at the end of the transaction which changes the balance is input from a payment terminal including a unit that changes the balance by sending the balance change information to the IC module; and an executing function of executing the group of processing by the procedure stored in the storing unit in a state in which the procedure is related to the sound pattern when a sound indicating the sound pattern corresponding to the sound effect is input via the sound inputting unit.

### EFFECT OF THE INVENTION

In the present invention, by focusing attention on the fact that a predetermined sound effect is output from a payment terminal at the end of a transaction by which the balance stored in an IC module is changed, access is made to the IC module when a sound of a pattern corresponding to the sound effect is input.

Therefore, access to the balance made by a mobile terminal of the present invention is less likely to be affected by the other processing and is less likely to affect the other processing.

### BRIEF DESCRIPTION OF DRAWINGS

FIG. 1 is a diagram for explaining the network configuration of an electronic money system according to this embodiment;

FIG. 2 is a diagram for explaining the configuration of a mobile terminal;

FIG. 3 is a diagram for explaining the function of the mobile terminal;

FIG. 4 is a diagram for explaining the configuration of an asynchronous payment terminal;

FIG. 5 is a diagram for explaining the configuration of an electronic money server;

FIG. 6 is a diagram for explaining a user DB and a recharging registration DB of the electronic money server;

FIG. 7 is a diagram depicting an example of an automatic recharging setting screen;

FIG. 8 is a flowchart depicting a processing procedure of registration of automatic recharging setting;

FIG. 9 is a flowchart depicting a processing procedure of this embodiment;

FIG. 10 is a flowchart depicting the processing procedure of this embodiment;

FIG. 11 is a flowchart depicting the processing procedure of this embodiment;

FIG. 12 is a diagram depicting an example of a screen asking the user to enter a recharging amount;

FIG. 13 is a diagram for explaining an example in which detection is performed by an acceleration sensor; and

FIG. 14 is a diagram for explaining an existing electronic money system.

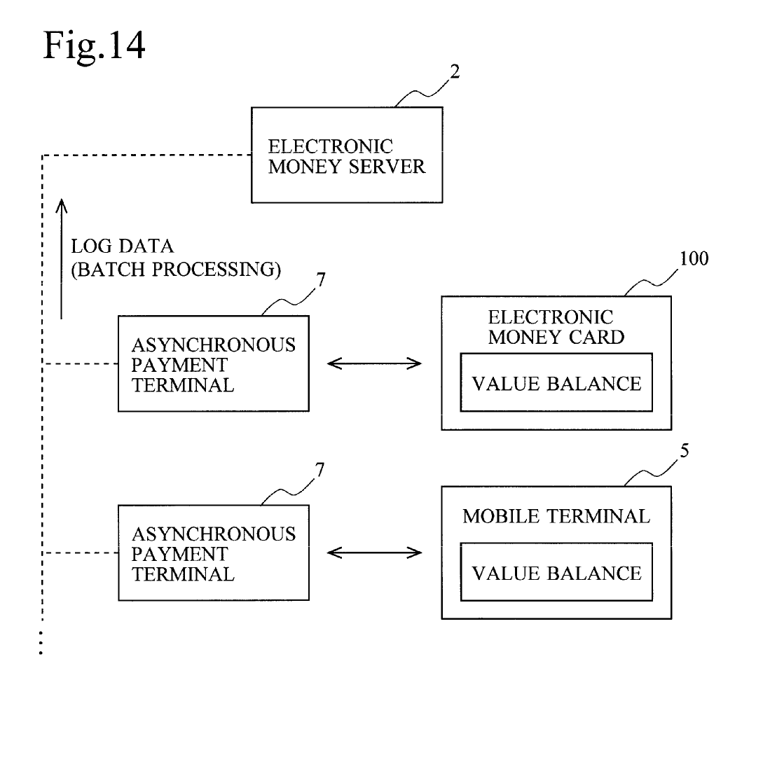

### DESCRIPTION OF EMBODIMENTS

(1) Outline of an Embodiment

When payment is completed, an asynchronous payment terminal 7 produces a sound effect indicating the completion of payment from a speaker 146, and, if the payment amount is more than the value balance, since payment processing by electronic money is impossible, the speaker 146 of the asynchronous payment terminal 7 produces a sound effect indicating that payment is impossible in order to notify the user thereof. These sound effects are detected by a microphone 20 of a mobile terminal 5.

An electronic money application 29 determines whether the sound effect detected by the microphone 20 is a sound effect produced when payment is completed or a sound effect produced when payment is impossible. The electronic money application 29 makes this determination by comparing the sound effect with a sound pattern stored in a storing section 18 of the mobile terminal 5.

As a result, if the electronic money application 29 determines that the sound effect indicating the completion of payment has been detected, the electronic money application 29 compares the value balance with a predetermined threshold value, and, if the value balance is less than the threshold value, immediately performs recharging.

On the other hand, if the electronic money application 29 determines that the sound effect indicating that the payment is impossible has been detected, since there is not enough value balance, the electronic money application 29 immediately performs recharging processing.

As described above, since a next transaction is started immediately after the completion of the transaction between a payment terminal and an IC module, the transactions do not mix and therefore do not affect each other.

(2) Details of the Embodiment

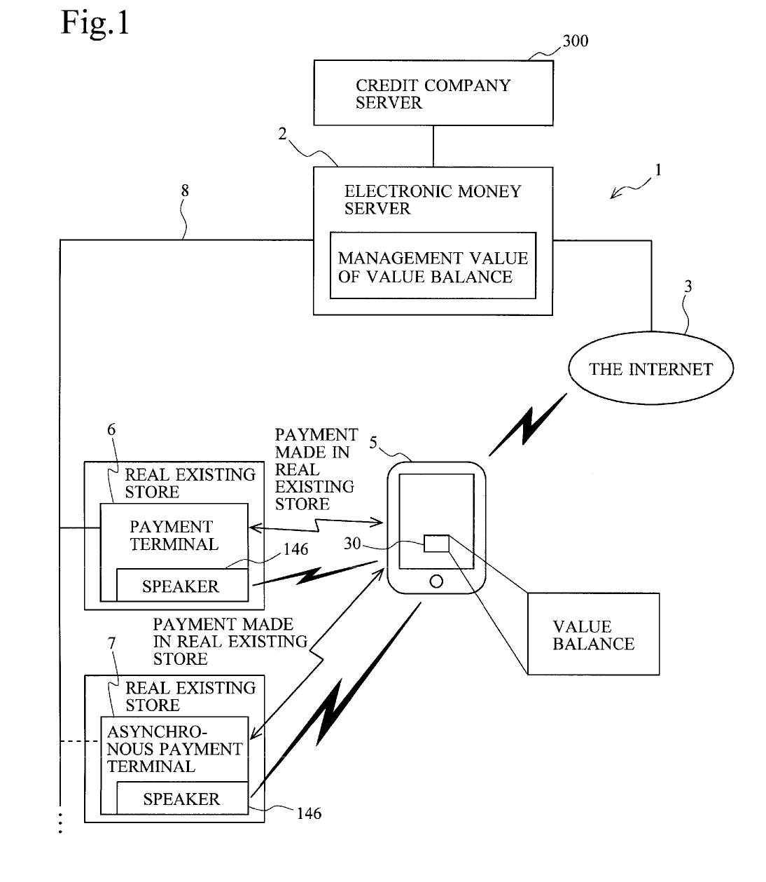

FIG. 1 is a diagram for explaining the network configuration of an electronic money system 1 according to a first embodiment.

The electronic money system 1 is configured by using an electronic money server 2, the Internet 3, the mobile terminal 5, a synchronous-type payment terminal 6, the asynchronous payment terminal 7, a communication line 8, a credit company server 300, and so forth.

The electronic money server 2 is a server that manages the transfer of money value by value. Here, value is electronic information related to money value, and the electronic money system 1 transfers money value by increasing or decreasing the balance of value (hereinafter, a value balance).

In addition, a business entity of the electronic money system 1 relates the transfer of value to the transfer of actual money by transferring actual money in response to the transfer of value.

The electronic money server 2 stores a management value of a value balance in a state in which the management value is related to the mobile terminal 5 for management. As will be described later, the mobile terminal 5 stores a value balance in an IC module 30 incorporated into or attached to the mobile terminal 5.

It is preferable that they are the same value as a result of being always synchronized with each other. However, in actuality, there are a large number of asynchronous payment terminals 7 that cannot establish real-time connection to the electronic money server 2. Therefore, the generated log data is sent to the electronic money server 2 later by batch processing to make them in synchronism with each other ex post facto.

In this embodiment, a stored value-type electronic money system that manages value on the side of the mobile terminal 5 (an electronic money card 100) will be described, but the present invention can also be applied to a server-type electronic money system that manages value on the side of the electronic money server 2. This case is based on the premise that the synchronous-type payment terminal 6 is used as a payment terminal.

The mobile terminal 5 is a mobile terminal formed as, for example, a smartphone, a mobile telephone, a game console, a tablet computer, or the like and has the function of connecting to the Internet 3 and the function of connecting to the payment terminal 6 and the asynchronous payment terminal 7 by short-distance radio communication.

The mobile terminal 5 has the IC module 30 incorporated thereinto or attached thereto and stores an electronic money number and a value balance therein.

The synchronous-type payment terminal 6 performs short-distance radio communication with the mobile terminal 5 and also performs communication with the electronic money server 2 via the communication line 8, thereby sending information such as a payment amount to the electronic money server 2 and relaying the communication between the electronic money server 2 and the mobile terminal 5. The synchronous-type payment terminal 6 is a synchronous payment terminal that performs online communication with the electronic money server 2 in real time at the time of payment using the mobile terminal 5.

The synchronous-type payment terminal 6 is installed in an accounting counter, an automatic vending machine, or the like of a real existing store (a real existing store that is physically open in a real existing store or the like) such as a convenience store.

The communication line 8 is a line that connects the electronic money server 2 with the synchronous-type payment terminal 6 or the asynchronous payment terminal 7. As the communication line 8, a dedicated line can be used, and a general-purpose line such as the Internet 3 may also be used.

The asynchronous payment terminal 7 is installed in, for example, a store and an automatic vending machine with inconvenient network equipment and has the function of performing short-distance radio communication with the mobile terminal 5.

The asynchronous payment terminal 7 makes payment by using the value balance by performing short-distance radio communication with the mobile terminal 5. The asynchronous payment terminal 7 is usually not connected to the electronic money server 2 (therefore cannot make payment by using server-type electronic money) and temporarily stores the details of payment performed between the asynchronous payment terminal 7 and the mobile terminal 5 as log data.

Then, the asynchronous payment terminal 7 connects to the electronic money server 2 around once a day, for example, by using the communication line 8 and sends the log data to the electronic money server 2. In an environment with no network communication equipment, a person in charge sometimes manually collects a recording medium on which the log data is recorded.

As for the value balance, the electronic money server 2 manages the fund transfer based on the log data in the synchronous-type payment terminal 6 and the asynchronous payment terminal 7.

The synchronous-type payment terminal 6 and the asynchronous payment terminal 7 each include the speaker 146 and are configured to produce a predetermined sound effect when payment is completed or payment is impossible. The mobile terminal 5 is configured to be capable of receiving this sound with the microphone 20.

The credit company server 300 is a server used by a credit company to manage payment by credit card. When the electronic money server 2 recharges the IC module 30, the credit company server 300 makes payment for recharging by using a credit number of the user.

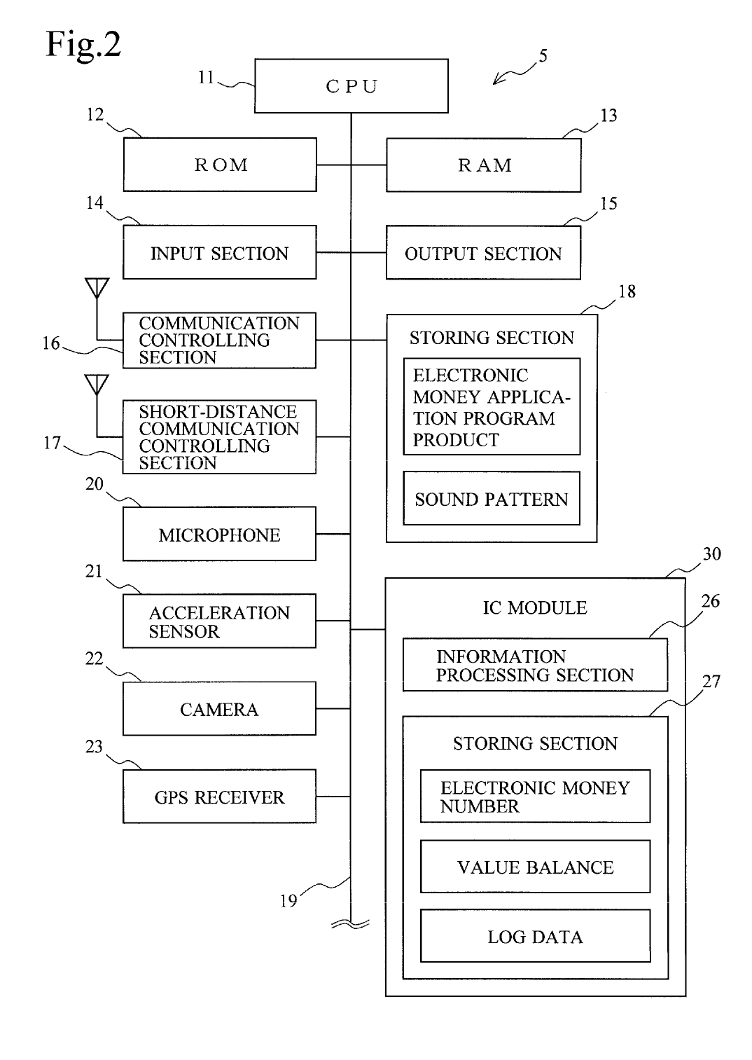

FIG. 2 is a diagram depicting the hardware configuration of the mobile terminal 5. Here, as an example, it is assumed that the mobile terminal 5 is a smartphone, but the same goes for a mobile telephone.

The game console and the tablet computer usually do not have the function of performing radio communication on a base station antenna of a mobile telephone network and often have only the function of performing radio communication with an access point of a wireless LAN. Incidentally, there are models of smartphones also having the function of performing radio communication with the access point of the wireless LAN.

The mobile terminal 5 is formed of a CPU (Central Processing Unit) 11, ROM (Read Only Memory) 12, RAM (Random Access Memory) 13, an input section 14, an output section 15, a communication controlling section 16, a short-distance communication controlling section 17, the storing section 18, the microphone 20, an acceleration sensor 21, a camera 22, a GPS receiver 23, the IC module 30, and so forth which are connected to one another by a bus line 19.

The CPU 11 performs various kinds of information processing and overall control of the mobile terminal 5 by executing a program product recorded on the ROM 12 and the storing section 18. In this embodiment, for example, the CPU 11 supports payment processing using the value balance by cooperating with the electronic money server 2 by the function provided by an electronic money application program product which will be described later.

The ROM 12 is read-only memory, and a basic program product used by the mobile terminal 5 to operate, a parameter, data, and so forth are recorded thereon.

The RAM 13 is readable/writable memory and offers working memory used when the CPU 11 performs information processing.

The output section 15 is a functional section that outputs information to the user and is provided with a liquid crystal display for screen display, a speaker from which sound is output, and so forth. On the liquid crystal display, for example, an icon for starting the electronic money application program product is displayed.

The input section 14 is a functional section that inputs information from the outside and is provided with, for example, a touch panel installed on the liquid crystal display. By touching the touch panel in response to the display on the liquid crystal display, the user can enter information.

The storing section 18 is formed by using, for example, a recording medium such as an EEPROM (Electrically Erasable and Programmable ROM) and a hard disk, and an OS (Operating System) which is a basic program product that controls the mobile terminal 5, the electronic money application program product that supports payment by value, pattern information indicating a sound pattern of each sound effect which is output from the payment terminal, and other program products and data are recorded thereon.

The communication controlling section 16 includes an antenna for performing radio communication with the base station antenna of the mobile telephone network and connects the mobile terminal 5 to the Internet 3 or a telephone line. The mobile terminal 5 can perform communication with the electronic money server 2 through the communication controlling section 16 via the Internet 3.

Moreover, the smartphone also has the function of performing radio communication with the access point of the wireless LAN.

The short-distance communication controlling section 17 includes an antenna for performing short-distance radio communication with reader/writers of the synchronous-type payment terminal 6 and the asynchronous payment terminal 7 and connects the IC module 30 to the synchronous-type payment terminal 6 or the asynchronous payment terminal 7. Moreover, the short-distance communication controlling section 17 has a plurality of terminals, and, when an electromagnetic wave of a particular frequency (for example, a carrier wave of 13.56 MHz) is detected, each corresponding terminal is turned on. In addition to performing communication with the payment terminal 6 via the short-distance communication controlling section 17, the IC module 30 can perform communication with the electronic money server 2 via the mobile terminal 5.

The IC module 30 is an IC module that stores a general-purpose application and is incorporated into or attached to the mobile terminal 5. The user can download an application and store the application in the IC module 30.

The IC module 30 is formed of a CPU, RAM, ROM, and so forth and is provided with an information processing section 26 that performs information processing in accordance with various program products and a storing section 27 formed of nonvolatile memory.

In the storing section 27, an electronic money number and a value balance and, though not depicted in the drawing, a value operation program product used by the information processing section 26 to operate the value balance, authentication data used by the electronic money server 2 to authenticate the IC module 30, and so forth are stored.

The electronic money number is a number used by the electronic money server 2 to identify the user of the mobile terminal 5 (the IC module 30).

Reduction processing and increase processing related to the value balance in the IC module 30 are performed by the value operation program product formed in the information processing section 26 in the IC module 30 in accordance with an instruction from the outside. This is performed in order to increase security by limiting processing of the value balance to the inside of the IC module 30.

Incidentally, as for processing of the value balance, information to be input to the IC module 30 is encrypted and is decoded in the IC module 30, and the information to be output from the IC module 30 is output after being encrypted in these chips.

The microphone 20 receives sound from the outside, specifically, sound (a sound effect) which is produced from the synchronous-type payment terminal 6 or the asynchronous payment terminal 7 when payment is completed or payment is impossible and converts the sound into an electrical signal.

The acceleration sensor 21 is an inertial sensor intended for measurement of the acceleration. By measuring the acceleration and performing signal processing, the acceleration sensor 21 can obtain various information such as the inclination, movement, and vibrations of the mobile terminal 5, the impact on the mobile terminal 5, and so forth.

The GPS receiver 23 can measure the current position of the mobile terminal 5 by receiving radio waves from a plurality of GPS satellites and calculating the distance from each GPS satellite.

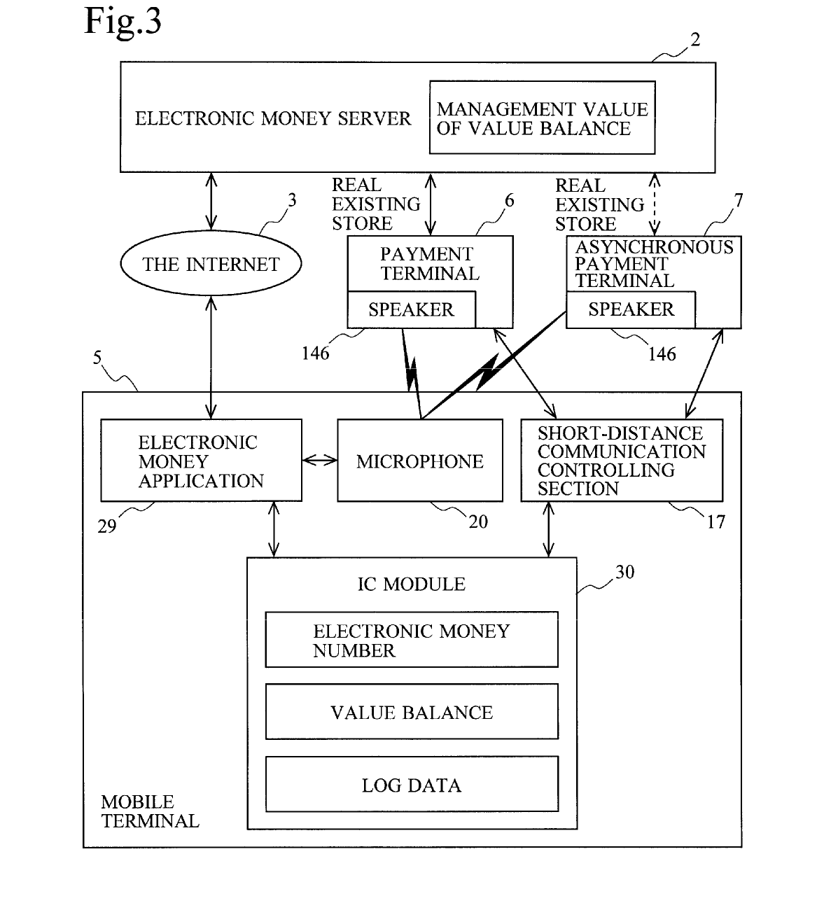

FIG. 3 is a diagram for explaining the function of the mobile terminal 5.

When the electronic money application program product is executed, the electronic money application 29 is formed in the mobile terminal 5.

In the case of payment in a real existing store provided with the synchronous-type payment terminal 6, the short-distance communication controlling section 17 performs communication with the payment terminal 6 and performs communication with the electronic money server 2 via the payment terminal 6.

In the case of payment in a real existing store provided with the asynchronous payment terminal 7, the short-distance communication controlling section 17 performs communication with the asynchronous payment terminal 7.

Moreover, the electronic money application 29 can access the IC module 30.

In the case of payment in a real existing store, the short-distance communication controlling section 17 can increase or decrease the value balance and read the electronic money number by operating the value operation program product in the IC module 30.

Then, when payment processing is performed, the IC module 30 receives, via the short-distance communication controlling section 17, a request from the asynchronous payment terminal 7 to update (reduce) the value balance and updates (reduces) the terminal-side value balance.

As the value balance update processing that is performed here, the following methods are possible.

(Method 1) A Case Where an Overwriting Instruction is Sent as a Value Balance Update Request.

In this case, the electronic money server 2 subtracts a payment amount from the value balance received from the CPU of the IC module 30 of the mobile terminal 5 and calculates the balance after subtraction. Then, the asynchronous payment terminal 7 sends, as a value balance update request, an overwriting instruction by which overwriting is performed on the balance after calculation. The CPU of the IC module 30 of the mobile terminal 5 performs update by performing overwriting with the value balance in accordance with the overwriting instruction.

(Method 2) A Case Where a Subtraction Instruction is Sent as the Value Balance Update Request.

In this case, the asynchronous payment terminal 7 sends a subtraction instruction by which a payment amount is subtracted from the value balance to the CPU of the IC module 30 of the mobile terminal 5 as the value balance update request. The CPU of the IC module 30 of the mobile terminal 5 updates the value balance by subtracting the payment amount from the value balance in accordance with the instruction.

Then, the IC module 30 notifies the asynchronous payment terminal 7 of the update of the value balance.

Next, recharging which is performed in a real existing store will be described.

This recharging is based on the premise that a store clerk who operates the asynchronous payment terminal 7 has received money corresponding to value by which recharging is performed. Then, when recharging processing is performed, the IC module 30 receives, via the short-distance communication controlling section 17, a request from the asynchronous payment terminal 7 to update (increase) the value balance and updates (increases) the value balance.

Then, the IC module 30 notifies the asynchronous payment terminal 7 of the update of the value balance.

In this recharging, recharging can also be performed directly from the electronic money server 2 without the asynchronous payment terminal 7. In this case, access is made to the electronic money server 2 via the communication controlling section 16 of the mobile terminal 5, and the procedures such as user authentication processing, permission from an authentication organization server such as the credit company server 300, and so forth are executed. Then, the mobile terminal 5 receives amount change (increase) information from the electronic money server 2, and the IC module 30 updates (increases) the value balance.

This recharging from the electronic money server 2 is performed as a series of processing. Therefore, it is impossible to complete the processing instantaneously and it takes a specific amount of time to complete the processing.

Making settings such that this recharging from the electronic money server 2 is performed automatically under a certain condition (for example, when the value balance becomes smaller than or equal to a predetermined value) is referred to as automatic recharging. By setting this automatic recharging, it is possible to prevent a situation in which payment cannot be made at the time of payment due to a shortage of value when payment is needed.

The mobile terminal 5 is provided with the microphone 20 for input of sound thereto, and a payment completion sound and a sound indicating that payment is impossible that are produced by the synchronous-type payment terminal 6 or the asynchronous payment terminal 7 or audio guidance is input thereto.

Processing which is performed when these sounds are input will be described later.

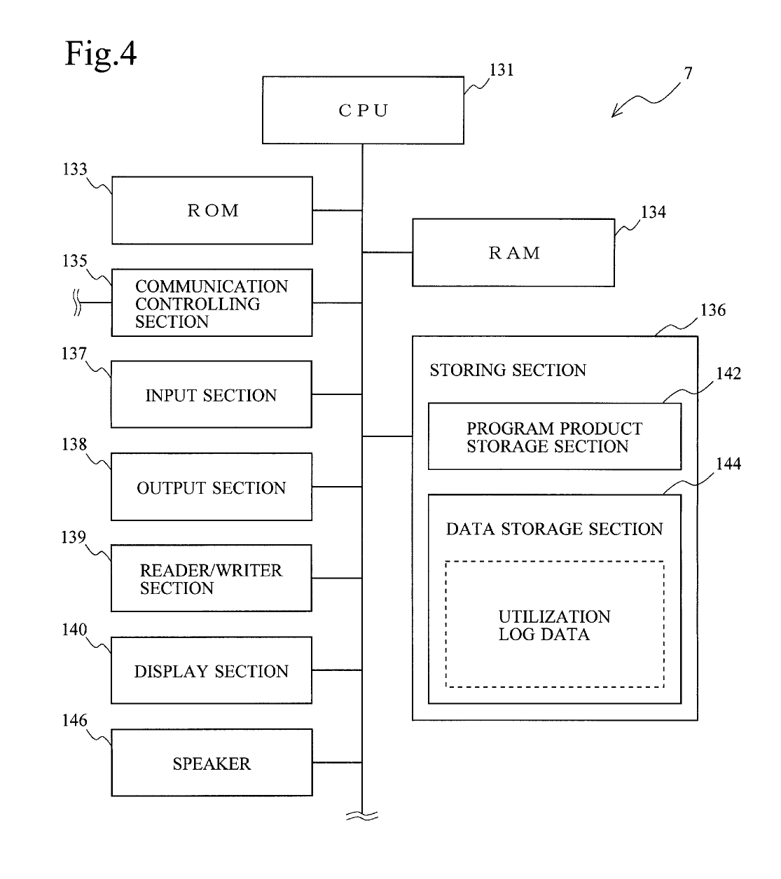

FIG. 4 is a diagram depicting an example of the hardware configuration of the asynchronous payment terminal 7.

The asynchronous payment terminal 7 is formed of a CPU 131, ROM. 133, RAM. 134, a communication controlling section 135, a storing section 136, an input section 137, an output section 138, a reader/writer section 139, a display section 140, the speaker 146, and so forth which are connected to one another by a bus line and has the function as a payment processing device.

In addition to performing information processing in accordance with a predetermined program product, the CPU 131 performs, for example, overall control of the asynchronous payment terminal 7. In this embodiment, the CPU 131 sends amount change information to the IC module 30 of the mobile terminal 5 to make the IC module 30 perform amount change processing.

The ROM 133 is read-only memory storing a basic program product for making the asynchronous payment terminal 7 operate, a parameter, and so forth.

The RAM 134 is memory on which writing and reading can be performed at any time, the memory that offers working memory of the CPU 131 and loads the program product and the data stored in the storing section 136 and stores the program product and the data.

The communication controlling section 135 is a connection device that connects the asynchronous payment terminal 7 to the electronic money server 2 via a network.

If the asynchronous payment terminal 7 is the asynchronous payment terminal 7 installed in a store, the input section 137 is provided with an input device such as a keyboard and a barcode reader, for example, such that an operator can enter a product code, a payment amount, a recharging amount, and so forth.

Moreover, if the asynchronous payment terminal 7 is the asynchronous payment terminal 7 installed in a pass gate, the input section 137 is connected to a control device of the pass gate, for example, and accepts the input of the payment amount from the control device of the pass gate.

If the asynchronous payment terminal 7 is the asynchronous payment terminal 7 installed in a store, the output section 138 is connected to, for example, the display section 140 of a liquid crystal display device or the like, a printer, the speaker 146 that outputs sound, and so forth and presents information to a customer or an operator of a member store.

Moreover, if the asynchronous payment terminal 7 is the asynchronous payment terminal 7 installed in a pass gate, for example, the output section 138 is connected to a drive unit that drives a gate door and a warning lamp, an audio output device, and the like which are installed in the pass gate, and opens and closes the gate door and makes the warning lamp flash or produces a warning tone in synchronism with the opening and closing of the gate door.

The reader/writer section 139 incorporates an antenna and performs radio communication with the IC module 30 incorporated into or attached to the mobile terminal 5.

If the asynchronous payment terminal 7 is the asynchronous payment terminal 7 installed in a store, the reader/writer section 139 is installed near a cash register, such that the user can bring the mobile terminal 5 or the electronic money card 100 closer to the reader/writer section 139 when paying for a product.

Moreover, if the asynchronous payment terminal 7 is the asynchronous payment terminal 7 installed in a pass gate, the reader/writer section 139 is installed on the top face of the pass gate in a position closer to the front than a gate door, such that the user can bring the mobile terminal 5 or the electronic money card 100 closer to the reader/writer section 139 when passing through the pass gate.

The storing section 136 is formed of, for example, a hard disk or other storage media and a drive unit that drives them, and is formed of a program product storage section 142 that stores various program products, a data storage section 144 that stores data, and so forth.

In the program product storage section 142, an OS that is a basic program product for making the payment terminal 6 function, a program product for making the electronic money card 100 perform amount change processing and making the electronic money server 2 perform recharging to add an amount corresponding to a shortfall, and so forth are stored.

In the data storage section 144, a terminal ID which is ID information of the asynchronous payment terminal 7, utilization log data which is the history of transactions with the mobile terminal 5 or the electronic money card 100, and so forth are stored. This utilization log data is sent to the electronic money server 2 by batch processing that is performed by the CPU 131.

The display section 140 displays a payment amount, a pre-payment balance, a post-payment balance, an amount corresponding to a shortfall when payment is impossible, and so forth on the liquid crystal display device, for example.

The speaker 146 informs the user of the payment completion sound, the sound indicating that payment is impossible, the audio guidance, or the like which is output from the output section 138. Here, the audio guidance is guidance for the user, such as “Payment cannot be performed due to a shortage of the balance.” or “This electronic money card cannot be accepted.”.

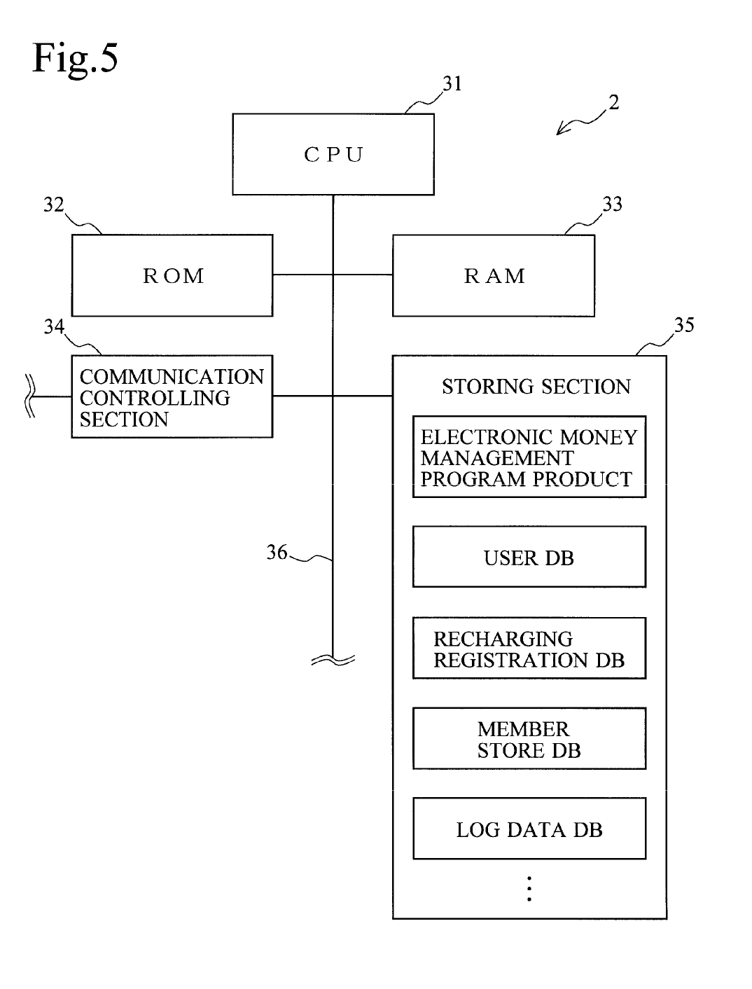

FIG. 5 is a diagram for explaining the configuration of the electronic money server 2.

The electronic money server 2 is formed of a CPU 31, ROM 32, RAM 33, a communication controlling section 34, a storing section 35, and so forth which are connected to one another by a bus line 36.

The CPU 31 performs various kinds of information processing and overall control of the electronic money server 2 by executing the program product stored in the ROM 32 and the storing section 35. For example, the CPU 31 receives a recharging request from the mobile terminal 5 and performs recharging.

In payment with the asynchronous payment terminal 7, the electronic money server 2 processes the payment by receiving, from the asynchronous payment terminal 7 at a later time, the log data of the update of the value balance performed by the asynchronous payment terminal 7.

Incidentally, in the case of the synchronous-type payment terminal 6 that can be connected to the electronic money server 2 online, it is possible to perform payment processing by value by updating the value balance in real time while performing communication.

The ROM 32 is read-only memory, and a basic program product used by the electronic money server 2 to operate, a parameter, data, and so forth are recorded thereon.

The RAM 33 is readable/writable memory and offers working memory used when the CPU 31 performs information processing.

With the communication controlling section 34, the electronic money server 2 performs communication with the synchronous-type payment terminal 6, the asynchronous payment terminal 7, and the mobile terminal 5 via the communication line 8 and performs communication with the mobile terminal 5 via the Internet 3.

The storing section 35 is formed of, for example, a large-capacity hard disk, and an electronic money management program product and other program products which are used by the CPU 31 to perform payment processing by value and perform recharging, a user DB (database) managing a user's value balance and the history of recharging, a recharging registration DB, a member store DB managing value payment performed in a member store, a log data DB storing log data which is a record of each payment processing, and so forth are recorded thereon.

Incidentally, in this example of FIG. 5, a single electronic money server 2 has been described, but this electronic money server 2 may be formed of a plurality of servers by distributing the function.

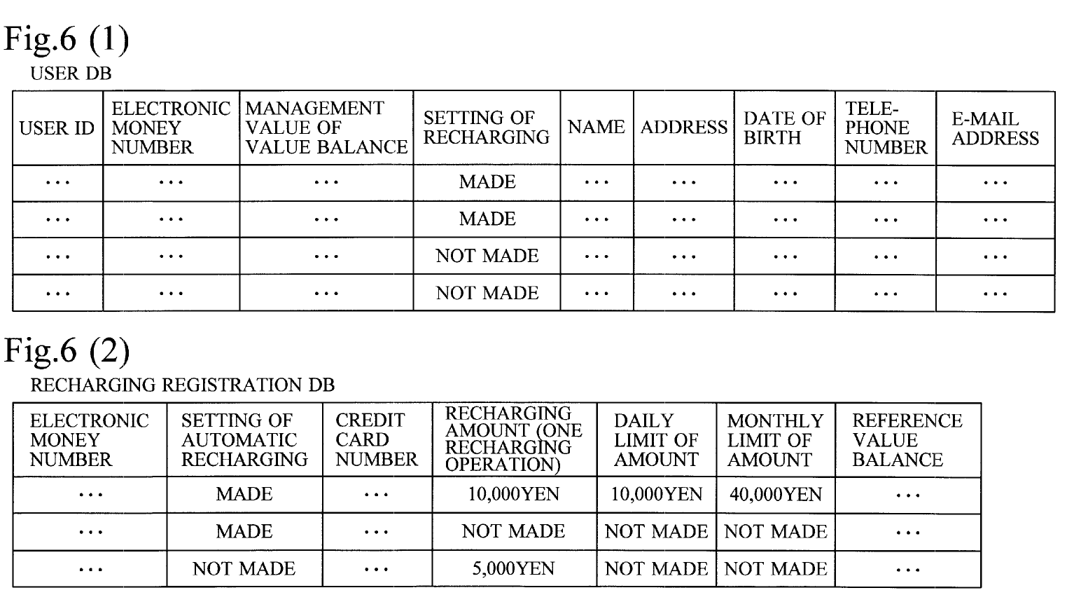

Next, by using the drawings of FIG. 6, the databases of the electronic money server 2 will be described.

FIG. 6(1) is a diagram for explaining the logical configuration of the user DB.

In this embodiment, an electronic money number is stored in a state in which the electronic money number is related to a user ID. Though not depicted in the drawing, items such as authentication data of the IC module 30 are also stored.

An item “user ID” is user identification information.

An item “electronic money number” is a number for distinguishing a value balance from the value balances of other users.

An item “management value of a value balance” is a value balance identified by the item “electronic money number”. This value balance is updated by using the received log data.

An item “setting of recharging” is a registration item for making an entry as to whether or not setting of recharging from the electronic money server 2 has been made.

Each of items “name”, “address”, “date of birth”, “telephone number”, and “e-mail address” is information for indentifying a user. All of these articles are not required registration items and may not be provided in some cases.

FIG. 6(2) is a diagram for explaining the logical configuration of the recharging registration DB.

The recharging registration DB is formed of “electronic money number”, “setting of automatic recharging”, “credit card number”, “recharging amount to be added by one recharging operation”, “daily limit of amount”, “monthly limit of amount”, “reference value balance”, and other items.

The item “electronic money number” is used as a key in searching for a user registered in the user DB.

The item “setting of automatic recharging” is a registration item indicating that the user has made not only setting of recharging from the electronic money server 2 but also setting of “automatic recharging”.

The “credit card number” is an item indicating the procurement source of recharging funds. Therefore, in some cases, “account number of a financial institution” or “ID determined by a telephone company which collects the telephone bill” is used.

When a plurality of payment means (a credit card, a deposit and savings account, and so forth) are used, the payment procedure can also be stored.

A withdrawal from a bank account is predicated on the presence of a contract between the user and a bank to make a withdrawal upon request from the electronic money server 2.

The items “recharging amount to be added by one recharging operation”, “daily limit of amount”, “monthly limit of amount”, and “reference value balance” are arbitrary setting items. When the user makes a request to make settings, these items are recorded.

Here, the recharging amount to be added by one recharging operation is the amount that is added to the IC module 30 of the mobile terminal 5 by one recharging operation. This setting eliminates the need to set the amount every time recharging is performed.

The daily limit of amount is the upper limit of the total recharging amount per day by recharging.

The monthly limit of amount is the upper limit of the total recharging amount per month. Moreover, a configuration may be adopted in which ceilings are set on the number of times per day and the number of times per month.

The reference value balance is a value balance used as a reference: when the value balance falls below this reference value balance, new recharging is performed. For example, a configuration can also be adopted in which recharging processing is urged by e-mail from the electronic money server 2 when the value balance falls below this reference value balance.

Moreover, when automatic recharging is set, recharging is performed automatically when the value balance falls below this reference value balance.

Here, a case where the recharging funds are added to the telephone bill will be described.

When the mobile terminal 5 has the telephone function and the user has made a contract with a mobile telephone company, it is also possible to add up the recharging amount and the telephone bill and charge the user to be billed.

This method is the same as a case where the purchase price of a digital content, for example, is added to the telephone bill.

In this case, the electronic money server 2 accesses a server of a mobile telephone business operator in place of the credit company server 300 and asks the server to collect the automatic recharging amount. At this time, the electronic money server 2 also notifies it of the ID notified from the mobile telephone business operator in advance.

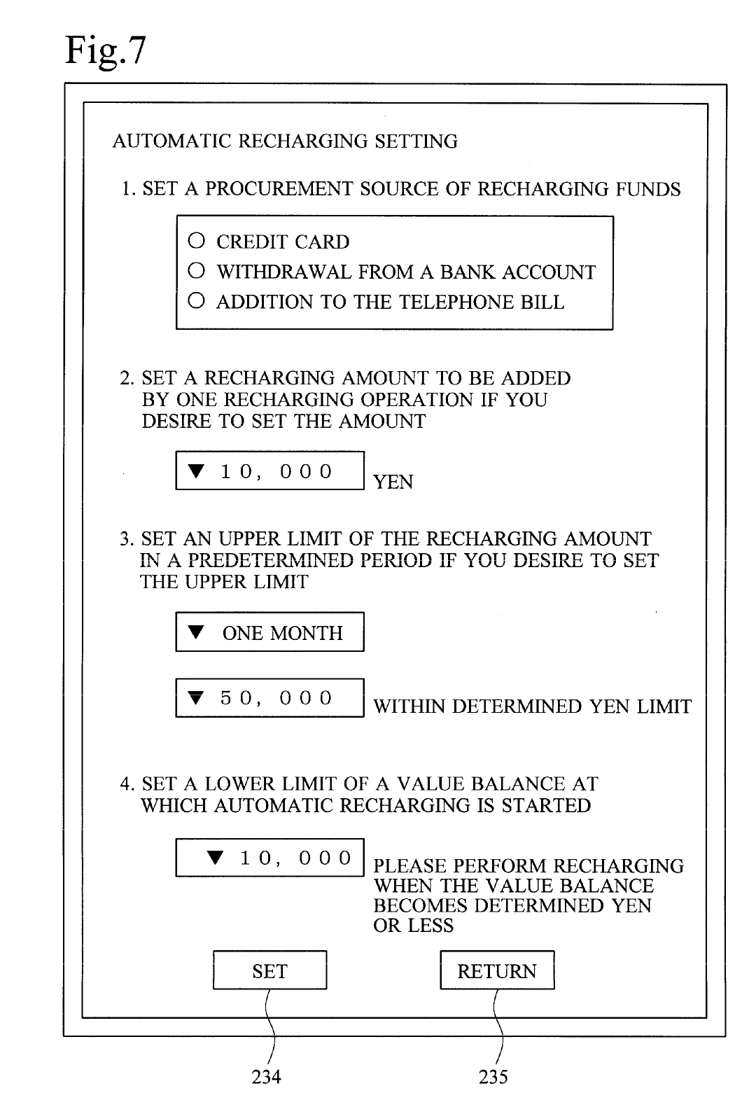

FIG. 7 is a diagram depicting an automatic recharging setting screen from the electronic money server 2, the automatic recharging setting screen which is displayed on the mobile terminal 5. Recharging from the electronic money server 2 according to this embodiment is predicated on the presence of user registration made in the electronic money server 2 in advance. This is because, unlike recharging based on cash (money) which is performed in a store, it is necessary to make it clear in advance how to procure the funds for recharging.

This automatic recharging setting screen from the electronic money server 2 is displayed by the electronic money application 29 by accessing the electronic money server 2.

Incidentally, as the screen provided to the mobile terminal 5 by the electronic money server 2, in addition to that described above, there are various screens such as a user registration screen and a recharging request screen.

On the “automatic recharging setting” screen from the electronic money server 2, under the display of “1. Set a procurement source of recharging funds”, “credit card”, “withdrawal from a bank account”, and “addition to the telephone bill” are displayed.

If there are other methods to secure funds, they are also displayed. Then, a selection made by the user from among them is received. The order of precedence may be set by making the user select multiple methods from among them.

Next, “2. Set a recharging amount to be added by one recharging operation if you desire to set the amount” is displayed.

This is an arbitrary setting article. This setting saves the trouble of entering a recharging amount every time automatic recharging is performed.

This field (the same goes for the following 3 and 4) is configured as a drop-down menu, and the user selects an amount. Incidentally, it can also be configured in such a way as to allow the user to enter an arbitrary amount.

Next, “3. Set an upper limit of the recharging amount in a predetermined period if you desire to set the upper limit” is displayed. This is also an arbitrary setting article. For example, setting is made such as “One day, within 10,000 yen limit” or “One month, within 50,000 yen limit”.

By making this setting, even when the mobile terminal 5 is stolen, it is possible to prevent the damage from spreading by successive recharging operations.

Next, “4. Set a lower limit of a value balance at which recharging is started” is displayed.

When the value balance falls below the set lower limit, for example, a notification may be provided from the electronic money server 2 by e-mail or the electronic money application 29 may display a message to that effect on a display screen of the mobile terminal 5. Moreover, a configuration may also be adopted in which recharging is performed automatically without providing a notification to the user. This case is based on the premise that a recharging amount to be added by one recharging operation has been set.

Furthermore, below each field described above, a set button 234 and a return button 235 are displayed.

The set button 234 is a button for notifying the electronic money server 2 of the contents selected by the user, and, when the set button 234 is selected, the electronic money application 29 sends the contents set by the user to the electronic money server 2.

The return button 235 is a button for returning to the screen displayed before the display of the automatic recharging setting screen.

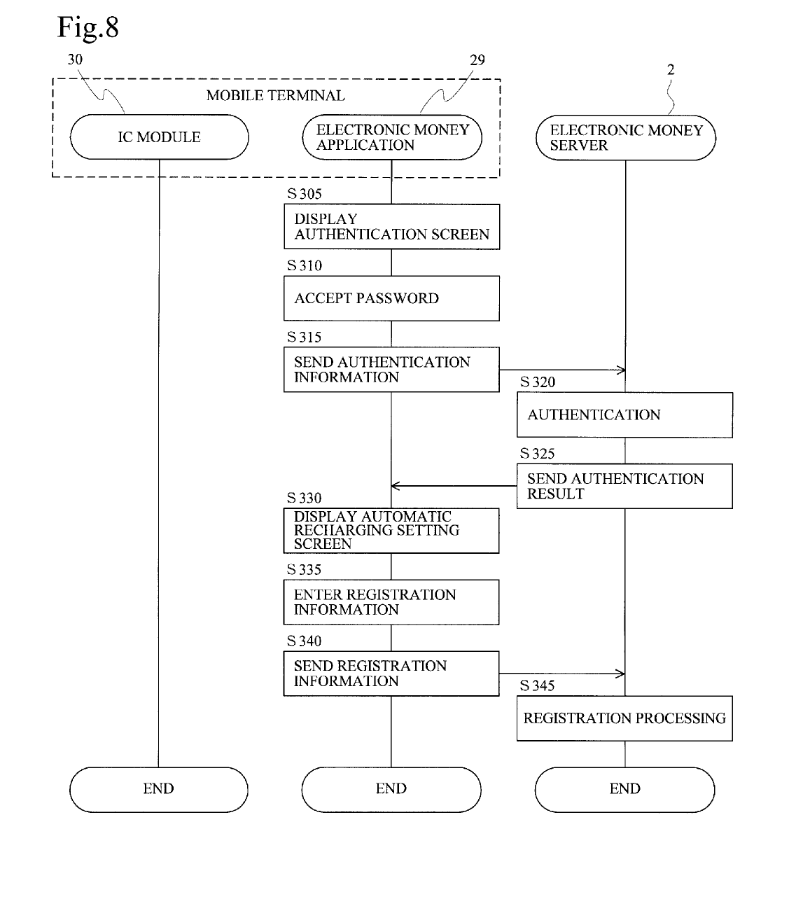

FIG. 8 is a flowchart for explaining the procedure for making registration of automatic recharging setting from the electronic money server 2.

The following processing is performed by the CPU implemented in the IC module 30 of the mobile terminal 5, the CPU 11 implemented in the mobile terminal 5, and the CPU 31 of the electronic money server 2 in accordance with an application program product for electronic money processing, a program product of the electronic money application 29, and a program product for the electronic money server.

First, the electronic money application 29 accesses the electronic money server 2 by the operation of the user. Then, the electronic money server 2 sends top screen data to the electronic money application 29, and the electronic money application 29 displays a top screen by using it. On the top screen, a button for automatic recharging setting is displayed.

When the user selects the button for automatic recharging setting, the electronic money application 29 displays an authentication screen on the display (step 305).

Incidentally, a configuration can also be adopted in which the mobile terminal 5 requests authentication screen data from the electronic money server 2 and displays the authentication screen by using the authentication screen data sent from the electronic money server 2 in response thereto.

On the authentication screen, a password entry field and a send button are provided, and, when the user enters a password in the password entry field, the electronic money application 29 accepts the password and temporarily stores the password in the RAM 13 or the like (step 310).

Then, when the user selects the send button, the electronic money application 29 inputs an ID reference command to the IC module 30, reads the electronic money number from the IC module 30, and sends the password stored in the RAM 13 and the electronic money number to the electronic money server 2 as authentication information (step 315).

When receiving the authentication information from the electronic money application 29, the electronic money server 2 performs authentication by comparing it with the password and the electronic money number stored in the user DB (step 320) and sends the authentication result to the electronic money application 29 (step 325).

When receiving the authentication result from the electronic money server 2, the electronic money application 29 displays an authentication result screen by using it.

If the electronic money server 2 has unsuccessfully authenticated the user, on the authentication result screen, the contents giving notice of an authentication error are displayed, and the user cannot perform setting of recharging.

On the other hand, if the electronic money server 2 has successfully authenticated the user, on the authentication result screen, regulations in getting recharging service and an agree button for entering an intention of agreeing to the regulations are displayed.

Incidentally, a configuration can be adopted in which the display of regulations and agreement thereto are performed at the time of an initial operation or when the regulations are revised.

When the user selects the agree button, the electronic money application 29 displays the automatic recharging setting screen depicted in FIG. 7 (step 330).

Incidentally, a configuration can also be adopted in which the mobile terminal 5 requests automatic recharging setting screen data from the electronic money server 2 and displays the automatic recharging setting screen by using the automatic recharging setting screen data sent from the electronic money server 2 in response thereto.

The electronic money application 29 accepts an entry of registration information (the procurement source of recharging funds, the recharging amount to be added by one recharging operation, the setting of an upper limit of recharging, and the lower limit of the value balance) as a result of the user selecting various conditions from the automatic recharging setting screen (step 335).

When the user selects the set button 234 (FIG. 7), the electronic money application 29 sends the registration information to the electronic money server 2 (step 340). At this time, the electronic money application 29 stores the lower limit of the value balance in the RAM 13 or the like in order to use the lower limit of the value balance later in checking the value balance.

The electronic money server 2 receives the registration information from the electronic money application 29 and performs registration processing by recording this on the recharging registration DB (step 345).

In this way, the registration processing about the automatic recharging service is completed.

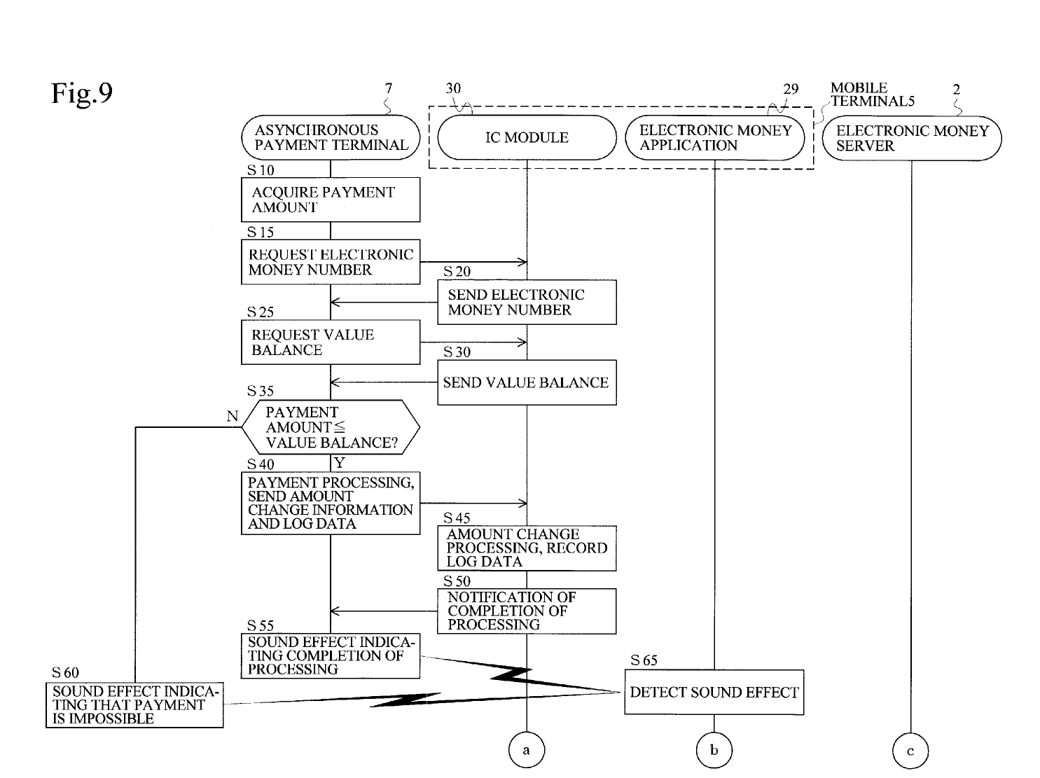

Next, the processing of this embodiment will be described with reference to flowcharts of FIGS. 9 to 11.

First, in a store, the user takes a product to purchase the product and asks a store clerk to make payment by electronic money. Then, the store clerk enters the price of the product, that is, a payment amount by using the keyboard, the barcode reader, or the like from the input section 137. In this manner, the asynchronous payment terminal 7 acquires the payment amount (step 10). Then, when the user passes the mobile terminal 5 over the reader/writer section 139 of the asynchronous payment terminal 7, the asynchronous payment terminal 7 requests the electronic money number from the IC module 30 incorporated into or attached to the mobile terminal 5 (step 15). In response to this request, the IC module 30 reads the electronic money number and sends the electronic money number to the asynchronous payment terminal 7 via the reader/writer section 139 (step 20).

Then, the asynchronous payment terminal 7 requests the current value balance from the IC module 30 (step 25). In response to this request, the IC module 30 sends the value balance to the asynchronous payment terminal 7 via the reader/writer section 139 (step 30).

Here, the asynchronous payment terminal 7 determines whether or not payment is possible with the sent value balance. That is, the asynchronous payment terminal 7 determines whether or not the payment amount acquired in step 10 is less than or equal to the value balance acquired in step 25 (step 35).

As a result, if the payment amount is less than or equal to the value balance (step 35; Y), since payment processing by electronic money is possible, the asynchronous payment terminal 7 sends amount change information based on which the value balance stored in the IC module 30 is rewritten and the log data concerning the payment to the IC module 30 (step 40).

In response to this, the IC module 30 updates (reduces) the value balance by using the amount change information sent thereto and records the log data on the storing section 27 (step 45).

After these processing is completed, the IC module 30 sends a notification that the processing has been completed to the asynchronous payment terminal 7 (step 50).

In response to this notification of the completion of the processing from the IC module 30, the asynchronous payment terminal 7 outputs a sound effect (an example of a completion sound) indicating the completion of payment from the speaker 146 (step 55). With this sound effect, the user recognizes that a series of payment processing has been completed and puts back the mobile terminal 5 passed over the reader/writer section 139. Moreover, the microphone 20 of the mobile terminal 5 detects this sound effect (step 65).

Incidentally, the asynchronous payment terminal 7 outputs the sound effect (an example of the completion sound) not only when the payment is completed but also when recharging in a store is completed.

On the other hand, if the payment amount is more than the value balance (step 35; N), since payment processing by electronic money is impossible, in order to notify the user of it, the speaker 146 of the asynchronous payment terminal 7 outputs a sound effect (an example of a sound indicating that a change in the balance is impossible) indicating that payment is impossible. Moreover, in order to provide the user with a more reliable notification, an audio message saying “Payment cannot be performed due to a shortage of the balance” may be played (step 60).

This sound effect or audio message is also detected by the microphone 20 of the mobile terminal 5 (step 65).

When the sound effect or the audio message is detected by the microphone 20, the electronic money application 29 determines whether the detected sound effect is the sound effect (the completion sound) indicating that the processing has been completed or the sound effect (the sound indicating that a change in the balance is impossible) indicating that the payment is impossible (step 70). The electronic money application 29 performs this determination by comparing the sound effect with the sound pattern stored in the storing section 18.

As a result, if the detected sound effect is the sound effect indicating that the processing has been completed (step 70; Y), the electronic money application 29 requests sending of the log data from the IC module 30 (step 75). In response to this, the IC module 30 outputs the log data to the electronic money application 29 (step 80).

The electronic money application 29 determines whether the processing was payment (processing by which the balance is reduced) or recharging (processing by which the balance is increased) by referring to the latest log data (step 85).

As a result, if the last processing was recharging (step 85; N), since it is possible to determine that further recharging is not needed, the electronic money application 29 ends the processing.

On the other hand, if the last processing was payment (step 85; Y), the electronic money application 29 determines whether or not the amount of payment is more than or equal to a predetermined threshold value (which is assumed to be a threshold value x here) based on the log data (step 90). If the amount of payment is more than the threshold value, for example, if the threshold value x is 10,000 yen and the amount of payment is 12,000 yen, the electronic money application 29 determines that recharging is needed immediately.

As a result of this determination, if the amount of payment is more than or equal to the threshold value x (step 90; Y), the electronic money application 29 proceeds to step 110 to perform recharging immediately.

On the other hand, if the amount of payment is less than the threshold value x (step 90; N), the electronic money application 29 requests the value balance from the IC module 30 (step 95).

In response to this, the IC module 30 outputs the value balance to the electronic money application 29 (step 100).

Here, the electronic money application 29 compares the value balance with a predetermined threshold value (which is assumed to be a threshold value y here) (step 105).

As a result, if the value balance is more than the threshold value y (step 105; N), the electronic money application 29 determines that there is no need to perform recharging immediately and ends the processing.

On the other hand, if the value balance is less than the threshold value y (step 105; Y), the electronic money application 29 proceeds to step 110 to perform recharging immediately.

The electronic money application 29 sends a recharging request to the electronic money server 2 by using the communication function of the mobile terminal 5 (step 110).

In response to this recharging request, the electronic money server 2 sends amount change information (increasing the amount) by using the communication function of the mobile terminal 5 (step 115).

Having received this, the IC module 30 performs processing by which the value balance is increased (step 120) and then sends an amount change completion notification to the electronic money server 2 (step 125).

The electronic money server 2 sends the amount change completion notification to the electronic money application 29 and ends the processing (step 130).

If the electronic money application 29 determines that the sound effect indicating in step 70 that the payment is impossible has been detected (step 70; N), since there is a shortage of the value balance, the electronic money application 29 performs recharging processing immediately.

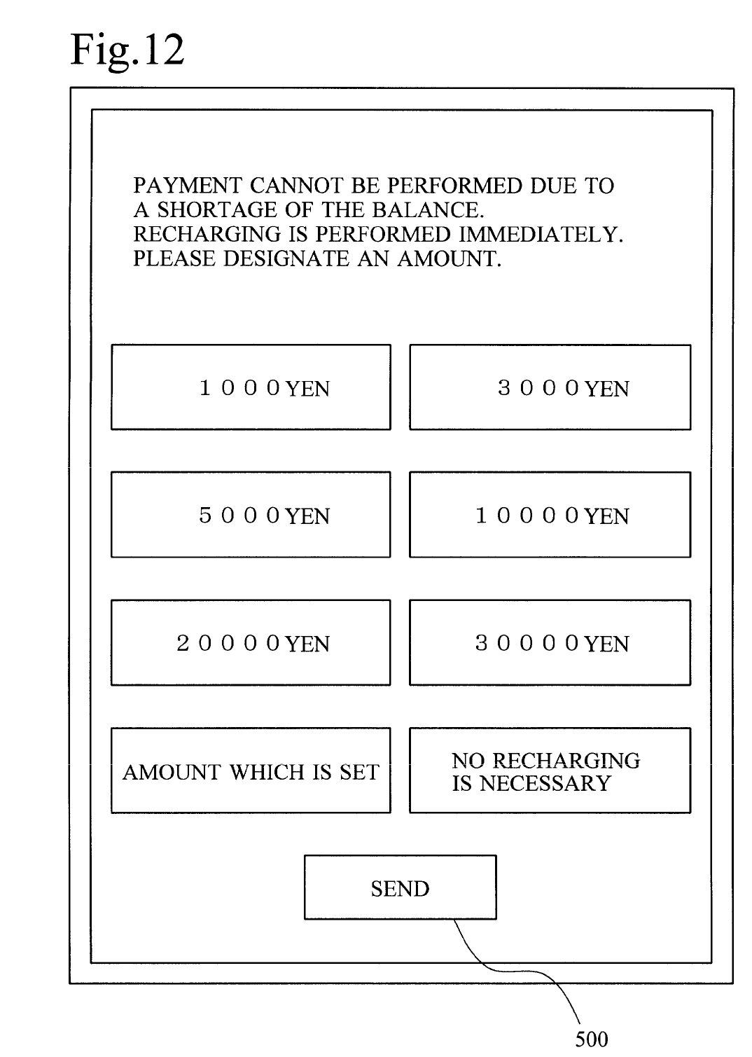

Here, since the electronic money application 29 cannot immediately grasp an amount corresponding to a shortfall which is a difference between the amount of payment and the value balance, the electronic money application 29 may display, for example, a selection screen depicted in FIG. 12 on the display screen of the mobile terminal 5 to make the user select a recharging amount (an amount the user asks to add to the value balance) (step 135).

Moreover, as another method, the electronic money application 29 may display, for example, the selection screen depicted in FIG. 12 on the display screen of the mobile terminal 5 to make the user select a target amount which is larger than the amount of payment and set an amount corresponding to a shortage of the value balance which is a difference between the value balance and the target amount, a recharging amount (an amount the user asks to add to the value balance), such that the value balance becomes the target amount.

Then, the electronic money application 29 sends a recharging request to the electronic money server 2 by using the communication function of the mobile terminal 5 (step 140).

In response to this recharging request, the electronic money server 2 sends the amount change information (increasing the amount) to the IC module 30 by using the communication function of the mobile terminal 5 (step 145).

Having received this, the IC module 30 performs processing by which the value balance is increased (step 150) and then sends an amount change completion notification to the electronic money server 2 (step 155).

The electronic money server 2 sends the amount change completion notification to the electronic money application 29 and ends the processing (step 160).

In this embodiment, the value balance is read and acquired from the IC module 30 in the processing in step 95, but the value balance recorded on the log data acquired in step 80 may be used.

Moreover, there is no need to perform the processing in step 90 and the processing in step 105 in parallel at all times, and, for example, it is also possible to omit the processing in step 90 and perform only step 105.

Furthermore, a value balance request to the IC module 30 in step 95 may be performed in advance, for example, before step 90 or step 85.

In this embodiment, it is based on the premise that a sound effect which is output when the processing has been successfully completed is identical to a sound effect which is output at the time of recharging, but, in the case of the asynchronous payment terminal 7 whose payment completion sound (an amount reduction completion sound) is different from a recharging completion sound (an amount increase completion sound) , it is possible to recognize the difference in step 70 based on the sound pattern.

Therefore, the processing in step 85 becomes unnecessary, and, if the sound is the payment completion sound, the procedure proceeds to step 90; if the sound is the recharging completion sound, since there is no need for recharging, the processing is ended.

In this embodiment, an example in which necessary recharging is performed immediately has been described. However, a recharging request may be reserved at the OS (Operating System) of the mobile terminal 5. For example, when a reservation is made such that recharging is performed at 11:00 p.m., if electronic money is not used at that time, recharging is not affected by the other processing involving access to the IC module 30 and does not affect the other processing likewise.

In this embodiment, an example in which the user is made to select a recharging amount when the electronic money server 2 is asked to perform recharging due to a shortage of the value balance (step 140) has been described (step 135, FIG. 12); however, it can also be configured such that the user takes an image of a payment amount which is displayed on the display section 140 of the asynchronous payment terminal 7 by using the camera 22 of the mobile terminal 5 and the electronic money application 29 or other applications perform character recognition processing on the image thus taken, whereby a payment amount is identified.

Then, the electronic money application 29 requests the electronic money server 2 to perform recharging of an amount which is larger than or equal to a difference between the identified amount and the value balance. The amount requested to be added may be the identified payment amount itself or may be a difference between the identified payment amount and the value balance.

Moreover, a recharging request and the taken image may be sent to the electronic money server 2, and a recharging amount may be determined on the side of the electronic money server 2.

Next, ON and OFF of the microphone 20 of the mobile terminal 5 will be described.

In this embodiment, the microphone 20 is used to acquire a sound effect, but leaving the microphone 20 in an ON state at all times is not desirable in terms of exhaustion of a battery. Ideally, the microphone 20 is turned on immediately before the generation of a sound effect and is turned off immediately after the generation thereof.

First, when the short-distance communication controlling section 17 detects an electromagnetic wave for short-distance radio communication (for example, a carrier wave of 13.56 MHz), the electromagnetic wave which is generated from the reader/writer section 139 of the asynchronous payment terminal 7, the CPU 11 (a controlling unit) brings the microphone 20 into an ON state immediately.

For example, it can be configured such that the short-distance communication controlling section 17 that has detected the electromagnetic wave for short-distance radio communication sends a predetermined signal to the CPU 11. Moreover, the CPU 11 constantly monitoring a particular terminal of the short-distance communication controlling section 17 performs control such that the microphone 20 is brought into an ON state immediately when a corresponding terminal is switched to ON with the detection of the electromagnetic wave for short-distance radio communication by the short-distance communication controlling section 17.

As another method, there is a method using the acceleration sensor of the mobile terminal 5.

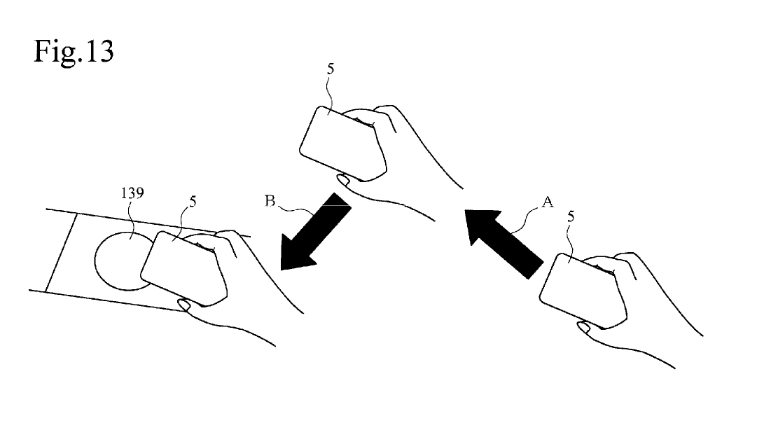

When the acceleration sensor 21 detects a pattern of a movement (indicated by an arrow A and an arrow B) depicted in FIG. 13, the movement which is produced when the user passes the mobile terminal 5 over the reader/writer section 139, or detects an impact which is produced when the mobile terminal 5 is made to touch the reader/writer section 139, control is performed such that the microphone 20 is brought into an ON state immediately.

Moreover, since the acceleration sensor 21 can make detection as to how many centimeters the mobile terminal 5 has moved in a given amount of time, the value thereof, for example, 30 cm may be set, and the microphone 20 may be turned on if the mobile terminal 5 moves 30 cm or more in a given amount of time.

The microphone 20 may be controlled by a combination of a pattern of a movement and a travel distance per unit time or a combination of an impact and a travel distance per unit time.

Furthermore, control may be performed such that the microphone 20 is brought into an ON state immediately if the acceleration in a direction (for example, a direction from a back face to a front face) opposite to a direction in which a face (for example, the back face) in which the IC module 30 of the mobile terminal 5 is placed faces the front exceeds a threshold value. This is based on the fact that, when the mobile terminal 5 is passed over the reader/writer section 139, slightly large acceleration in the direction (for example, the direction from the back face to the front face) opposite to the direction in which the face in which the IC module 30 is placed faces the front is detected.

Next, timing with which the microphone 20 is turned off will be described.

When the sound effect identical to the sound pattern stored in the storing section 27 of the mobile terminal 5 is detected, control to turn off the microphone 20 is performed. This is because the processing between the asynchronous payment terminal 7 and the IC module 30 has been completed at the stage of the detection of the sound effect.

By turning off the microphone promptly at the completion of the processing by the microphone in this manner, it is possible to suppress exhaustion of the battery.

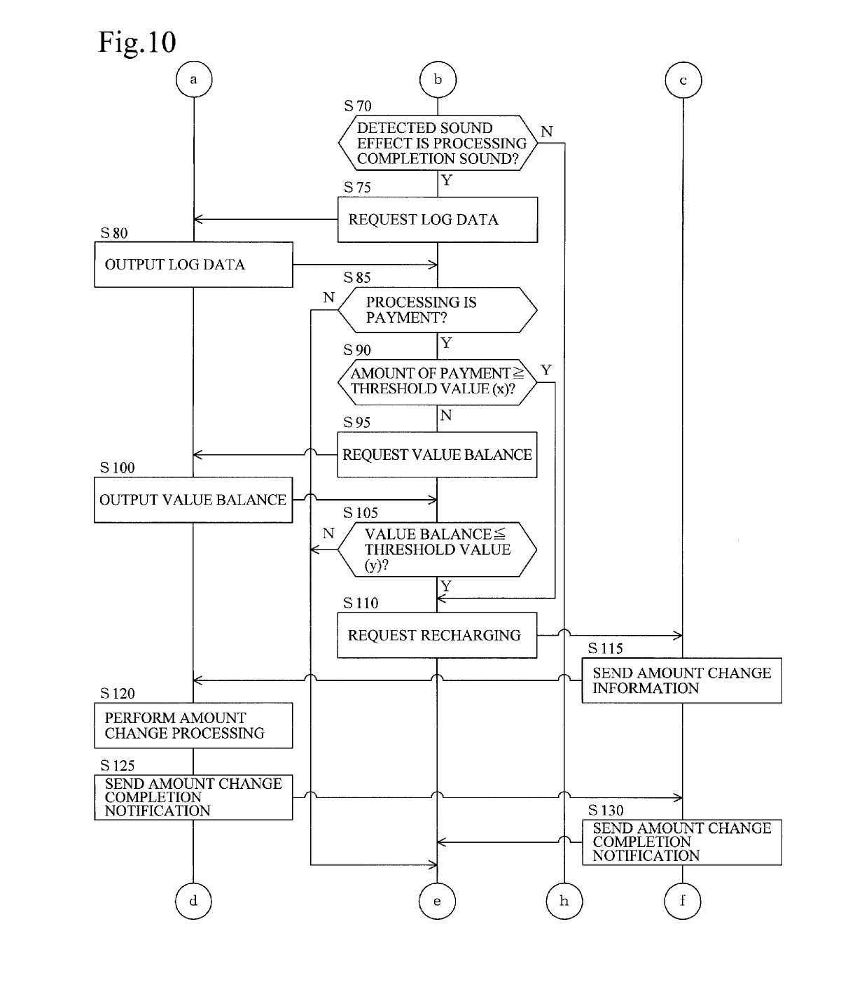

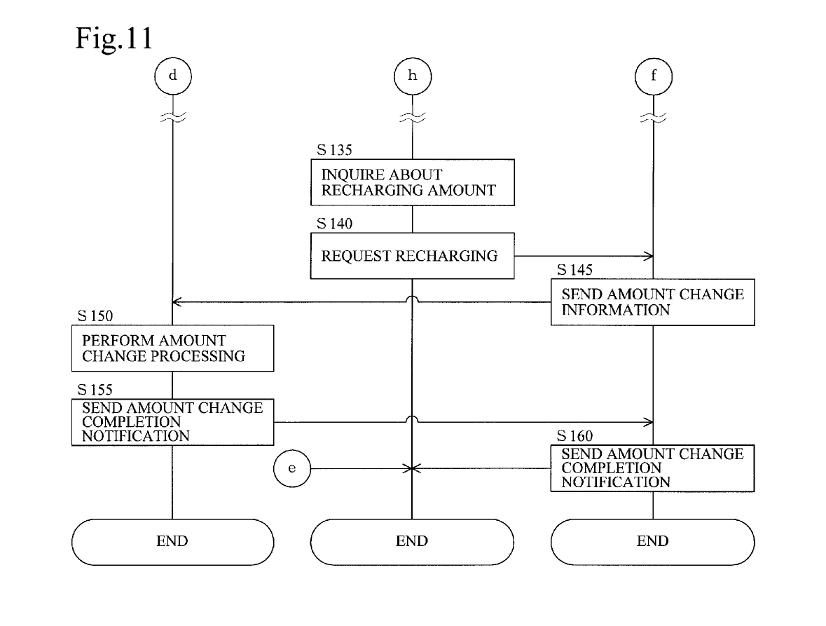

In addition to that described above, examples of timing with which the microphone 20 is turned off include a time after a reservation for recharging has been made, for example, a time after determination that recharging is unnecessary has been made, the determination made in step 85 and step 105 of FIG. 10, a time after connection to send a recharging request to the electronic money server 2 from the mobile terminal 5 has been established, the connection established in step 110 of FIG. 10 and step 140 of FIG. 11, and a time after recharging described in step 130 of FIG. 10 and step 160 of FIG. 11 has been completed.

Moreover, timing may be started from the time at which the microphone 20 is turned on and control may be performed such that the microphone 20 is turned off after a lapse of a predetermined time (for example, 30 seconds or 1 minute).

Next, other timing with which the microphone 20 is turned on/off will be described.

Control to turn on/off the microphone 20 is performed in accordance with the location, the situation, and a period of time in which the user, that is, the mobile terminal 5 is in.

For example, the microphone 20 is turned on when the user enters a store in which the asynchronous payment terminal 7 is installed and is turned off when the user leaves the store. Determination as to whether the user enters or leaves the store may be made by using the GPS receiver 23 of the mobile terminal 5.

Moreover, control may be performed such that the microphone 20 is turned on when the user passes through a ticket wicket of a station and enters the station and is tuned off when the user passes through the ticket wicket of the station and leaves the station or, by using the acceleration sensor 21 of the mobile terminal 5, the microphone 20 is turned on if the user is moving and is turned off if the user stays in the same place for a predetermined time or longer.

Furthermore, control may be performed based on a time period such that the microphone 20 is turned off in a time period in which electronic money is usually not used, for example, from 23:00 to 7:00 of the following day and is turned on in the other period of time.

According to this embodiment, by using the existing asynchronous payment terminal 7, mobile terminal 5, IC module 30, and electronic money server 2, that is, without preparing a special new device or the like, it is possible to prevent a plurality of transactions involving access to the IC module 30 from mixing and affecting each other.

### EXPLANATIONS OF LETTERS OR NUMERALS

1 electronic money system

2 electronic money server

3 the Internet

4 electronic money card

5 mobile terminal

6 payment terminal

7 asynchronous payment terminal

8 communication line

11 CPU

12 ROM

13 RAM

14 input section

15 output section

16 communication controlling section

17 short-distance communication controlling section

18 storing section

19 bus line

20 microphone

21 acceleration sensor

22 camera

23 GPS receiver

26 information processing section

27 storing section

29 electronic money application

30 IC module

31 CPU

32 ROM

33 RAM

34 communication controlling section

35 storing section

36 bus line

100 electronic money card

146 speaker

300 credit company server

1.-22. (canceled)

23. A mobile terminal comprising:
a storing unit that stores a procedure of a group of processing that establishes access to a balance of electronic value that is stored in an IC module in a state in which the procedure is related to a sound pattern of a sound effect which a payment terminal outputs at an end of a transaction, the payment terminal including a unit that makes the IC module change the balance by sending balance change information to the IC module and a unit that outputs the sound effect at the end of the transaction which changes the balance, and the IC module including a unit that stores the balance and a unit that changes the balance by using the balance change information;
a controlling unit that controls a sound inputting unit such that the sound effect is input from the payment terminal;
a judging unit that judges whether a sound indicating the sound pattern of the sound effect is input via the sound inputting unit; and
a determining unit that determines that, if the judging unit judges that the sound is input, it is necessary to execute the group of processing by the procedure.

24. The mobile terminal according to claim 23, comprising:
an executing unit that executes the group of processing by the procedure if the determining unit determines the execution of the group of processing by the procedure to be necessary.

25. The mobile terminal according to claim 24, wherein
the sound effect is a completion sound effect which is output when the balance stored in the IC module has been changed, and
the group of processing includes necessity determination processing that determines a necessity or not of addition to the balance.

26. The mobile terminal according to claim 25, wherein
the necessity determination processing is processing by which a necessity of addition to the balance is determined by using predetermined data which is acquired from the IC module, and
the executing unit includes a data acquiring unit that acquires the predetermined data stored in the IC module and a necessity determining unit that determines a necessity or not of addition to the balance by using the predetermined data which is acquired by the acquiring unit.

27. The mobile terminal according to claim 26, wherein
the data acquiring unit includes a balance acquiring unit that acquires the balance stored in the IC module, and
the necessity determining unit determines that there is a need to perform addition to the balance if the balance which is acquired by the balance acquiring unit is less than or equal to a predetermined threshold value.

28. The mobile terminal according to claim 26, wherein
the IC module further includes a unit that stores log data containing an amount of change indicating a reduction or an increase of the balance by the transaction,
the data acquiring unit includes a change amount acquiring unit that acquires the amount of change contained in latest log data from the IC module, and
the necessity determining unit that determines that there is a need to perform addition to the balance if the amount of change which is acquired by the change amount acquiring unit indicates a reduction and an amount of reduction indicated by the amount of change is more than or equal to a predetermined threshold value.

29. The mobile terminal according to claim 25, wherein
the IC module further includes a unit that stores log data containing an amount of change indicating a reduction or an increase of the balance by the transaction,
the data acquiring unit includes a change amount acquiring unit that acquires the amount of change contained in latest log data from the IC module, and
the necessity determining unit determines that there is no need to perform addition to the balance if the amount of change which is acquired by the change amount acquiring unit indicates an increase.

30. The mobile terminal according to claim 25, wherein
the group of processing further includes balance addition processing by which addition to the balance stored in the IC module is performed, the balance addition processing which is to be executed if determination is made in the necessity determination processing that there is a need to perform addition to the balance, and
the executing unit further includes an addition requesting unit that sends a balance addition request to a server device and a balance change information transferring unit that acquires balance change information which increases the balance stored in the IC module, the balance change information generated and sent by the server device, and transfers the balance change information to the IC module.

31. The mobile terminal according to claim 25, wherein
the group of processing further includes balance addition reservation processing by which addition to the balance stored in the IC module is performed with designated timing, the balance addition reservation processing which is to be executed if determination is made in the necessity determination processing that there is a need to perform addition to the balance, and
the executing unit further includes a unit that makes a reservation such that a balance addition request is sent, with designated timing, to a server device, an addition requesting unit that sends the balance addition request to the server device with the designated timing, and a balance change information transferring unit that acquires balance change information which increases the balance stored in the IC module, the balance change information generated and sent by the server device, and transfers the balance change information to the IC module.

32. The mobile terminal according to claim 25, wherein
as the completion sound effect, there are a reduction completion sound effect which is output when the balance stored in the IC module has been reduced and an increase completion sound effect which is output when the balance has been increased,
the storing unit stores a procedure of necessity determining processing by which a necessity or not of addition to the balance is determined in a state in which the procedure is related to the sound pattern of the reduction completion sound effect,
the judging unit judges whether the sound indicating the sound pattern of the reduction completion sound effect is input and
the executing unit executes the necessity determining processing only when the judging unit judge the sound indicating the sound pattern of the reduction completion sound effect is input.

33. The mobile terminal according to claim 24, wherein
the sound effect is an incompletion sound effect which is output when the balance stored in the IC module has not been successfully changed and indicates the change in the balance is impossible, and
the group of processing includes balance addition processing by which addition to the balance is performed.

34. The mobile terminal according to claim 33, wherein
the executing unit includes
an addition request amount sending unit that sends an addition request amount to a server device provided with a unit generating the balance change information, and
a balance change information transferring unit that acquires balance change information which increases the balance stored in the IC module by the addition request amount and transfers the balance change information to the IC module.

35. The mobile terminal according to claim 34, wherein
the executing unit includes
a designated amount acquiring unit that acquires a designated amount which is designated by a user, and
an addition request amount setting unit that sets the addition request amount such that the balance stored in the IC module becomes more than or equal to the designated amount which is acquired by the designated amount acquiring unit.

36. The mobile terminal according to claim 34, wherein
the executing unit includes
an image acquiring unit that acquires an image obtained by taking an image of a payment amount which is displayed on a display device of the payment terminal, and
an addition request amount setting unit that sets the addition request amount such that the balance stored in the IC module becomes more than or equal to the payment amount which is identified based on the image which is acquired by the image acquiring unit.

37. The mobile terminal according to claim 34, wherein
the executing unit includes
an addition request amount acquiring unit that acquires an addition request amount which is designated by a user.

38. The mobile terminal according to claim 23, wherein
the controlling unit switches the sound inputting unit to ON when an electromagnetic wave of a particular frequency is detected by a unit that detects an electromagnetic wave of a particular frequency.

39. The mobile terminal according to claim 23, further comprising:
an acceleration sensor that detects a movement of the mobile terminal; and
an acceleration-related data storing unit that stores a predetermined movement pattern or threshold value of an acceleration of the movement,
wherein
the controlling unit switches the sound inputting unit to ON when the predetermined movement pattern or a movement exceeding the predetermined threshold value of the acceleration, the predetermined movement pattern or threshold value which is stored in the acceleration-related data storing unit, is detected by the acceleration sensor.

40. The mobile terminal according to claim 23, wherein
the controlling unit switches the sound inputting unit to ON when the controlling unit enters a predetermined location, a predetermined situation, or a predetermined period of time.

41. The mobile terminal according to claim 23, wherein
the controlling unit switches the sound inputting unit to OFF when a sound indicating the sound pattern of the sound effect is input via the sound inputting unit.

42. The mobile terminal according to claim 23, wherein
the controlling unit switches the sound inputting unit to OFF when a predetermined time has elapsed after the controlling unit has switched the sound inputting unit to ON.

43. A method for controlling a mobile terminal including a storing unit that stores a procedure of a group of processing that establishes access to a balance of electronic value that is stored in an IC module in a state in which the procedure is related to a sound pattern of a sound effect which a payment terminal outputs at an end of a transaction, the payment terminal including a unit that makes an IC module change the balance by sending balance change information to the IC module and a unit that outputs the sound effect at the end of the transaction which changes the balance, and the IC module including a unit that stores the balance and a unit that changes the balance by using the balance change information the method comprising:
a controlling step of controlling a sound inputting unit such that the sound effect is input from the payment terminal;
a judging step of judging whether a sound indicating the sound pattern of the sound effect is input via the sound inputting unit; and
a determining step of determining, if the judging step judges that the sound is input, it is necessary to execute the group of processing by the procedure.

44. A non-transitory computer-readable recording medium on which a program product is recorded, the program product for making a mobile terminal implement, the mobile terminal including a storing unit that stores a procedure of a group of processing that establishes access to a balance of electronic value that is stored in an IC module in a state in which the procedure is related to a sound pattern of a sound effect which a payment terminal outputs at an end of a transaction, the payment terminal including a unit that makes an IC module change the balance by sending balance change information to the IC module and a unit that outputs the sound effect at the end of the transaction which changes the balance, and the IC module including a unit that stores the balance and a unit that changes the balance by using the balance change information:
a controlling function of controlling a sound inputting unit such that the sound effect is input from the payment terminal; and
a judging function of judging whether a sound indicating the sound pattern of the sound effect is input via the sound inputting unit; and
a determining function of determining, if the judging function judges that the sound is input, it is necessary to execute the group of processing by the procedure.
